(19) United States
(12) Patent Application Publication
(10) Pub. No.: US 2011/0108489 A1
(43) Pub. Date: May 12, 2011

(54) INTEGRAL ELECTROLYTIC TREATMENT UNIT

(76) Inventors: Karl J. Fritze, Hastings, MN (US); Brian Luebke, Trempealeau, WI (US); Rudolph R. Hegel, Richfield, MN (US)

(21) Appl. No.: 12/813,367

(22) Filed: Jun. 10, 2010

Related U.S. Application Data
(60) Provisional application No. 61/185,863, filed on Jun. 10, 2009.

(51) Int. Cl. C02F 1/461; C02F 1/72; C02F 1/52

(52) U.S. Cl. 210/709; 210/192; 210/717; 210/98; 204/275.1; 204/228.3

(57) ABSTRACT

An electrolytic filtration system incorporating a filter vessel and an electrolytic element into a simple compact system which avoids the use of toxic chemicals and eliminates the need for large reservoirs to ensure adequate contact time to remove iron and other problem contaminants. The electrolytic filtration system includes a filter head having a control valve and an electrolytic generator. The control valve directs flow through the filter vessel and allows for an intermittent backwash cycle as desired. The electrolytic generator can be integrated into the filter head to provide ease of installation and reduce the overall footprint of the electrolytic filtration system. The electrolytic generator can include a flow sensor and power supply to provide for control of the electrolytic generator.

### RELATED APPLICATION

The present application claims the benefit of U.S. Provisional Application No. 61/185,863 filed Jun. 10, 2009, and entitled “INTEGRAL ELECTROLYTIC TREATMENT UNIT”, which is incorporated herein in its entirety by reference.

### FIELD OF THE INVENTION

The present invention relates generally to a fluid treatment system which electrolytically generates gases that are dissolved into fluid. More specifically, the present invention is directed to a filter system having a control head into which an electrolytic cartridge is integrated such that oxidized contaminants can be easily removed with a filter media.

### BACKGROUND OF THE INVENTION

Systems that are used to treat water intended for potable use are common and well known. In many of these residential and light commercial applications, the systems are designed to remove iron, manganese, and hydrogen sulphide. These systems can comprise arrangements of individual components that are often specified by water treatment professionals and installed by skilled service technicians. Generally, these systems are designed based on criteria such as, for example, flow rate, pH, target contaminants and cost. In some of the most common system designs, oxidizers such as ozone, chlorine, or potassium permanganate (KMnO4) can be added to the flow stream, or alternative, air can be injected into the water to as provide sufficient contact time and thorough mixing of oxygen and the contaminants. After these oxidizers or oxygen has had time to react with the contaminants, the contaminants are physically altered such that a particulate filter can remove the contaminants. Generally, these particulate filters are sized to remove large amounts of oxidized minerals followed by a back flushing or back washing cycle. During backwashing, filter media is fluidized using a reverse flow of water wherein the lightweight contaminants can be removed and flushed to a suitable drain. A typical operational cycle is shown in FIG. 26A while a conventional backwash sequence is illustrated in FIG. 26B.

Depending upon the contaminants to be removed and the ultimate use for the filtered water, these systems can be designed to use a wide variety of filter media. Representative types can include media such as Birm, manganese greensand, garnet, anthracite and sand and are especially effective in removing particulate matter from water.

Birm is a granular media which is coated so as to have a catalytic effect enhancing the oxidation reaction of iron or manganese. Birm comprises a silicon dioxide core surrounded with a manganese oxide outer coating. Regeneration is accomplished by mechanically scrubbing the media during backwashing which removes the contaminants and creates fresh manganese oxide surfaces. Birm requires oxygen be present in the water to oxidize metallic contaminants and should not be used above 10 ppm iron. Pyrolusite (MnO2), a manganese dioxide mineral, is commercially available as Pyrolox®. Pyrolox® is a registered trademark of ATEC Systems.

Manganese greensand is an olive-green colored sandstone rock mineral containing glauconite (an iron potassium silicate). When the oxidizing power of the manganese greensand is spent, it must be regenerated with a dilute solution of potassium permanganate. Manganese greensand can oxidize iron without any oxygen present and takes place by a redox reaction. Up to 10-15 ppm iron removal can be achieved if conditions are optimal, but 5 ppm is generally considered a practical limit.

Coarse media such as garnet, anthracite, or sand possess no catalytic effect or inherent oxidizing capability. However, they make good particulate filters which are easily cleansed by a conventional backwashing procedure.

Each of these systems has its own strengths and weaknesses in terms of cost, complexity, environmental impact etc. One issue in each of these systems is being able to integrate components into a compact integral system that provide for sufficient contact time. In most systems, oxidation of the contaminants can take up to several minutes of contact time. takes time, from one to several minutes. Using chlorine requires 20 minutes contact time before filtration. A typical 42 gallon pressure tank used with many well water systems can provide suitable contact time if the water is forced to pass through the tank and not bypass it using a tee type fitting. Systems that have contact times greater than one minute require a reservoir to allow sufficient contact time and as such complicate the practicality of an integral treatment unit. Any integrated system would require a large contact reservoir and a suitable backwashing filter.

Other media such as greensand can oxidize on contact. They do not require a reservoir to allow initial contact with the oxidizer. These systems provide enough contact time within the filter tank to oxidize the iron and filter the precipitated iron particles if the flow rates and pH are within acceptable limits. Unfortunately, this system requires the use of toxic potassium permanganate to regenerate the greensand.

As opposed to particulate filtration, water softening systems make use of ion exchange resin that selectively exchange sodium for hardness ions such as calcium, magnesium and iron to an extent. Over time, water softeners have undergone a design transition from the use of individual filter and brine tanks to system in which these tanks are combined into a single appliance along with the associated controls and valving. U.S. Pat. No. 4,026,801 to Ward discloses a representative water softening system wherein the filter tank, media, and valve are combined into an enclosure which also serves as a brine tank. U.S. Design Pat. D439,950 discloses a contoured appliance in design Pat. D 439,950 for a single tank water softener.

A variety of designs specifically contemplated for iron removal systems have been developed. U.S. Pat. No. 3,649,532 to McLean teaches s compact single-tank apparatus for aerating water, reacting it with oxygen in the air, and subsequently filtering it out in a suitable media. The unit as taught by McLean is cleaned by periodic backwashing. Even though the invention is deemed compact, these units are impractical due to the substantial size that a vessel needs in order to provide the required contact time to adequately remove the problem contaminants. Along the same lines, other prior art systems teach a water treatment system that integrates air-injection into a control valve which can be attached to a filter tank and is suitable for removing iron, manganese, and hydrogen sulphide. This system suffers from inadequate contact time for a complete oxidation reaction using air because the air injection is immediately before the filtration media.

U.S. Pat. No. 7,300,569 to Petty teaches an improvement for an integral water treatment system in which a lack of retention or contact time is rectified through the use of catalytic media such as Birm®, KDF®, or Filter AG®. While this provides for superior oxidation and removal, it still falls short as lacking an ability to treat and remove high concentrations of iron and hydrogen sulphide.

Another system as taught by U.S. Pat. No. 7,459,086 to Gaid employs the use of a special media containing ferric hydroxide in combination with manganese dioxide allowing iron, manganese, and arsenic to be removed from water by passing the contaminated water through a filter media without adding any oxidizers such as air, chlorine, potassium permanganate ozone, etc. Unfortunately, effective removal requires from a halt to ten minutes of contact time rendering the development of a compact, integral system difficult.

More recently, it has been discovered that treating water with electrolysis can lead to rapid and effective removal of large concentrations of iron, manganese and hydrogen sulphide. These systems pass electrical current through the water and its current conducting minerals. When the current passes through water, it is converted to a variety of ions, chemicals, and gases.

It is well know that electrolysis in an aqueous fluid evolves oxygen and hydrogen gases. The ratio of hydrogen to oxygen is 2:1, so that the amount of oxygen in the gas represents 33% with the balance being hydrogen. By generating bubbles of small enough size, these electrolytic units can saturate water with micro-bubbles of these gasses. When the water is saturate with gaseous oxygen, the contact time required to precipitate metallic ions such as ferrous iron is very rapid such that little if any additional contact time is required prior to the filtration process. In fact, many of these electrolysis systems are installed so as to operate after a pressure tank and directly in front of the filter. Even though the oxygen concentration is greater with electrolysis based systems as opposed to straight air injection systems, 33% vs. 21%, this does not account for the nearly instantaneous iron precipitation with an electrolytic unit compared to the required slow contact time of minutes for molecular oxygen oxidation.

Besides simple generation of oxygen and hydrogen gases, a wide array of high-energy chemical reactions occur during water electrolysis. A variety of oxygen-based oxidants are created including, for example, ozone, hydrogen peroxide, and atomic oxygen as well as hydrogen complexes including atomic hydrogen gas. Further, the hybrid water molecules that are derived from the loss of atoms of hydrogen become radicals and are very transitory and reactive. Gasses that are naturally found in the atmosphere are paired together such as H₂, N₂, and O₂. When the oxygen and hydrogen are initially evolved from the electron transfer during electrolysis, oxidation-reduction reactions require that only single (atomic) atoms of oxygen and hydrogen gasses be formed. These gasses are at a higher-energy and they rapidly combine with the resulting array of chemicals, contaminants, and redox agents. The excess gasses are dissolved into the water until saturation and then any excess gas coalesces to form large bubbles of gas. The resulting persistent forms of these gasses become molecular H₂, and O₂.

Based on the number of high energy reactions and oxygen/hydrogen species that are part of the electrolysis process, it is not surprising, therefore, that these electrolytic systems have been found to reduce contaminants beyond iron and manganese. For example, these electrolysis units have been found to successfully precipitate arsenic from aqueous fluids. It is believed that a wide array of metallic contaminants that are similarly exposed to the redox potential created by electrolysis systems will react similarly.

Typical electrolytic units are arranged for installation in a water system as a separate and distinct component. As the water passes through the electrolytic unit, the water and dissolved contaminants become exposed to the electrolytic activity, wherein the water and resulting gasses are carried toward a filter tank. The filter tank can be similarly sized as those used for water softeners such as, for example, 9″×48″, 10″×48″, or 12″×48″. Generally, the tank size is determined by a flow rate of the water to be treated. The duration and frequency of back washing is determined by the concentration of the problem contaminants.

These electrolysis based systems can benefit from placing the electrolytic unit after the pressure tank as these tanks can become plagued with precipitated iron and scale when they are used as contact reservoirs. The electrolytic unit should only operate in flowing water so it must have some means for determining when the flow of water starts. Many flow sensors are possible, but they must be very robust and not easily fouled by precipitated iron, etc. It is therefore desirable to place these flow sensors after the water has been treated and filtered. Placing a flow sensor directly after the electrolytic treatment unit can lead to material failures due to high-energy water and excessive scaling due to the precipitated minerals. Once the water has reacted with the iron etc. and passed through the filter, it is normalized and of good quality for potable use. The best place therefore is to place any flow sensor after the filter.

As discussed above, current designs of filtration system suffer a variety of problems that can lead to inefficiency and increased operational costs. As such, it would be beneficial to have new designs for electrolytic flow-through chambers that overcome the limitations of current devices.

### SUMMARY OF THE INVENTION

An electrolytic filtration system according to the present invention incorporates a filter vessel and an electrolytic element into a simple compact system which avoids the use of toxic chemicals and eliminates the need for large reservoirs to ensure adequate contact time to remove iron and other problem contaminants. The filtration system includes a control head assembly which directs flow through the filter vessel and allows for an intermittent backwash cycle as desired. The electrolytic element is integrated into the control head assembly to provide ease of installation and reduce the overall footprint of the filtration system. The control head assembly can also include a flow sensor and power supply to provide for control of an electrolytic generator. With the electrolytic filtration system of the present invention, it is desirable to place the electrolytic element as close to the filter assembly as possible to simplify the plumbing and reduce the fouling or plugging of pipes due to the precipitation of contaminants and dissolved minerals. Since the aqueous fluid to be treated must flow into the control head assembly and the filtered water flows out through the same control head assembly, a control valve becomes the best location to integrate an electrolytic unit. It is on the outlet from the control valve that a suitable flow sensor can reside due to its clean water source and close proximity to the electrolytic treatment unit. The flow sensor verifies flow through an outlet flow passage such that the electrolytic element is only powered when there is aqueous fluid flow through the electrolytic filtration system.

In one representative embodiment, an electrolytic filtration system can comprise a filter vessel containing a filter media and a control head assembly including an electrolytic generator. The control head assembly generally controls the flow of an aqueous fluid into the filter vessel. The control head assembly generally comprises a control valve, wherein the electrolytic generator, and more specifically, an electrolytic element can be positioned upstream or downstream of the control valve. The control head assembly can comprise a flow sensor in an outlet flow passage to verify aqueous flow through the electrolytic filtration assembly and to only power the electrolytic element when aqueous flow is detected by the flow sensor.

In another representative embodiment, a control head assembly for directing aqueous flow though a filter assembly ion system can comprise a control valve defining an inlet flow passage and an outlet flow passage and an electrolytic generator attached to the control valve, wherein the electrolytic generator is fluidly exposed to the inlet flow passage. The electrolytic generator, and more specifically, an electrolytic element can be positioned upstream or downstream of the control valve. The control head assembly can comprise a flow sensor in the outlet flow passage to verify aqueous flow through the outlet flow passage such that the electrolytic element is powered only when aqueous flow is detected by the flow sensor.

In yet another embodiment, a method for filtering an aqueous fluid can comprise providing a control head assembly including an electrolytic element that is fluidly exposed to an inlet flow passage. The control head assembly can then be attached to filter assembly including a filter media. The control head assembly can control aqueous fluid flow into the filter vessel. Power can be supplied to the electrolytic element to generate electrolytic byproducts within the aqueous fluid flow such that any contaminants are exposed to the electrolytic byproducts and precipitated contaminants are subsequently filtered out of the aqueous fluid flow with the filter media. In some embodiments, a flow sensor can be used to detect aqueous fluid flow within an outlet flow passage such that the electrolytic element is powered only when aqueous fluid flow is detected flowing through an electrolytic filtration assembly.

The above summary of the invention is not intended to describe each illustrated embodiment or every implementation of the present invention. The Figures and the Detailed Description that follow more particularly exemplify these embodiments.

### BRIEF DESCRIPTION OF THE FIGURES

The invention can be more completely understood in consideration of the following detailed description of various embodiments of the invention in connection with the accompanying drawings, in which:

FIG. 1 is a perspective view of an electrolytic filtration system having a rear mounted electrolysis unit according to an embodiment of the present invention.

FIG. 2 is a perspective view of the electrolytic filtration system of FIG. 1.

FIG. 3 is a side view of the electrolytic filtration system of FIG. 1.

FIG. 4 is a top view of the electrolytic filtration system of FIG. 1.

FIG. 5 is a side view of the electrolytic filtration system of FIG. 1.

FIG. 6 is a rear view of the electrolytic filtration system of FIG. 1.

FIG. 7 is a front view of the electrolytic filtration system of FIG. 1.

FIG. 7a is a section view of the integral filtration system of FIG. 1 taken at line A-A of FIG. 7.

FIG. 8 is a side view of an electrolytic sump assembly according to an embodiment of the present invention.

FIG. 8a is a rear view of the electrolytic sump assembly of FIG. 8.

FIG. 9 is a side view of the electrolytic sump assembly of FIG. 8.

FIG. 9a is a section view of the electrolytic sump assembly of FIG. 8 taken at line B-B of FIG. 9.

FIG. 10 is a top view of the electrolytic sump assembly of FIG. 8.

FIG. 10a is a section view of the electrolytic sump assembly of FIG. 8 taken at line C-C of FIG. 10.

FIG. 11 is a perspective view of the electrolytic sump assembly of FIG. 8.

FIG. 12 is an exploded, perspective view of the electrolytic sump assembly of FIG. 8.

FIG. 13 is a perspective view of an electrolytic filtration system having a bottom mounted electrolytic generator according to an embodiment of the present invention.

FIG. 14 is a perspective view of the electrolytic filtration system of FIG. 13.

FIG. 15 is a side view of the electrolytic filtration system of FIG. 13.

FIG. 16 is a top view of the electrolytic filtration system of FIG. 13.

FIG. 17 is a side view of the electrolytic filtration system of FIG. 13.

FIG. 18 is a rear view of the electrolytic filtration system of FIG. 13.

FIG. 19 is a front view of the electrolytic filtration system of FIG. 13.

FIG. 19a is a section view of the electrolytic filtration system of FIG. 13 taken at line A-A of FIG. 19.

FIG. 20 is a side view of an electrolytic manifold according to an embodiment of the present invention.

FIG. 20A is a section view of the electrolytic manifold of FIG. 20 taken at line D-D of FIG. 20.

FIG. 21 is a top view of the electrolytic manifold of FIG. 20.

FIG. 22 is a bottom view of the electrolytic manifold of FIG. 20.

FIG. 23 is a top, perspective view of the electrolytic manifold of FIG. 20.

FIG. 24 is a perspective view of an electrolytic blade pack according to an embodiment of the present invention.

FIG. 25 is a top, exploded, perspective view of the electrolytic manifold of FIG. 20.

FIG. 26A is a flow schematic for a conventional filtration system in a filtering mode.

FIG. 26B is a flow schematic for a conventional filtration system in a backwashing mode.

FIG. 27A is a flow schematic for the electrolytic filtration system of FIG. 1 in a filtering mode.

FIG. 27B is a flow schematic for the electrolytic filtration system of FIG. 1 in a backwashing mode.

FIG. 28A is a flow schematic for the electrolytic filtration system of FIG. 13 in a filtering mode.

FIG. 28B is a flow schematic for the electrolytic filtration system of FIG. 13 in a backwashing mode.

FIG. 29A is a flow schematic for an electrolytic filtration system having a single unitary, electrolytic filtration head according to an embodiment of the invention in a filtering mode.

FIG. 29b is a flow schematic for an electrolytic filtration system having a single unitary, electrolytic filtration head according to an embodiment of the invention in a backwashing mode.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE FIGURES

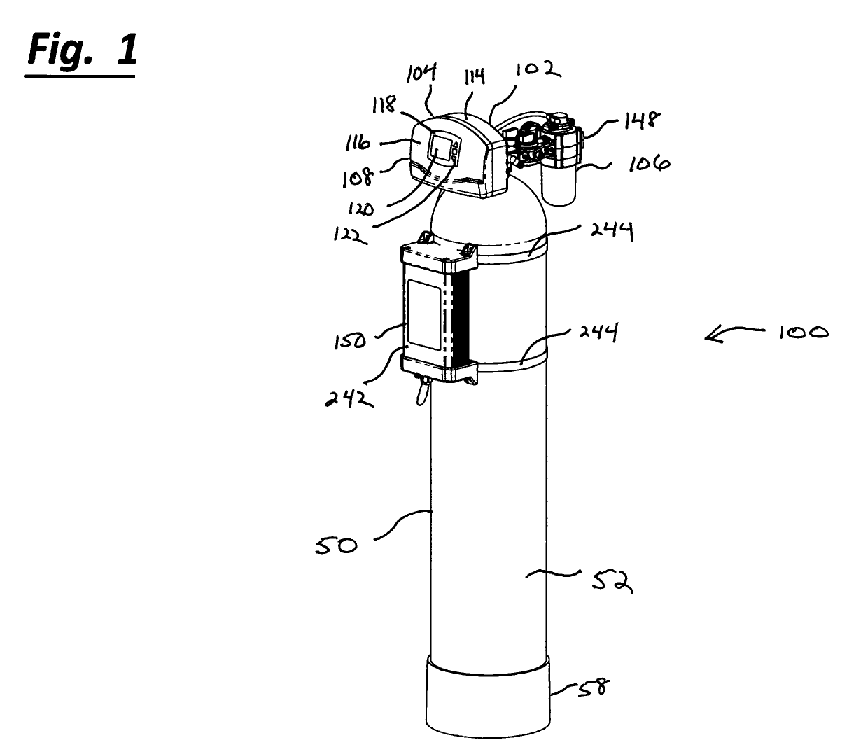

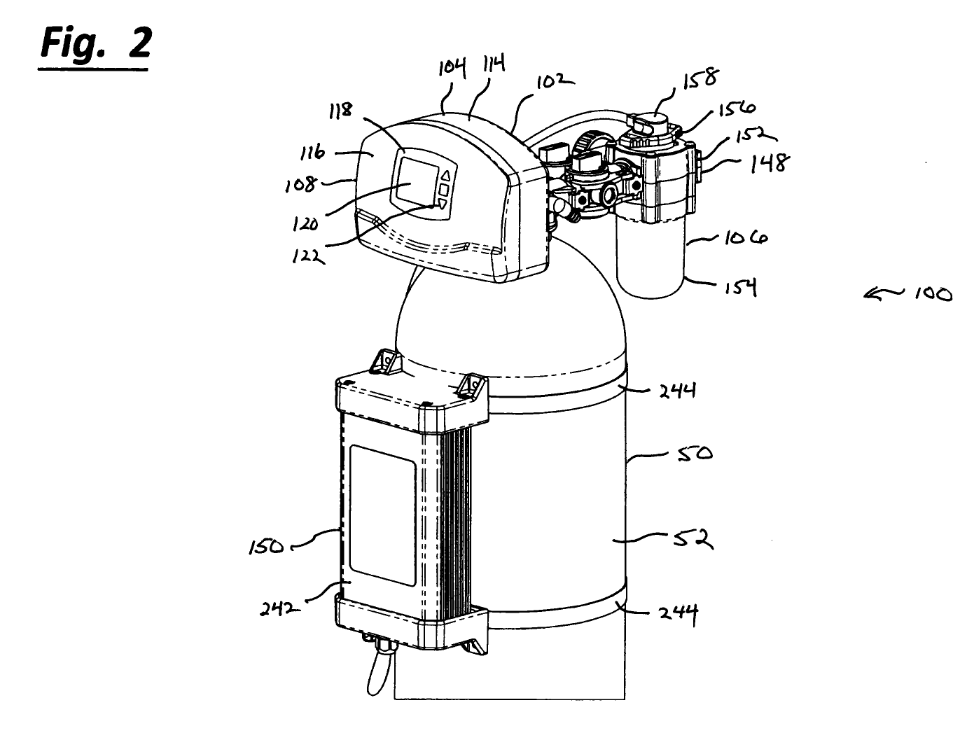

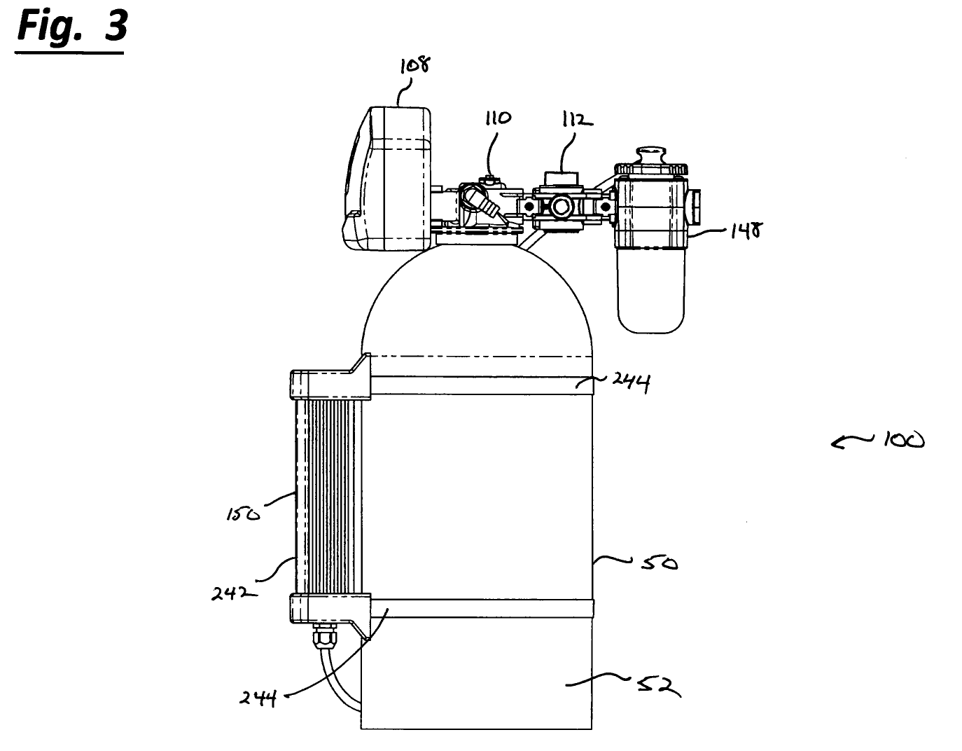

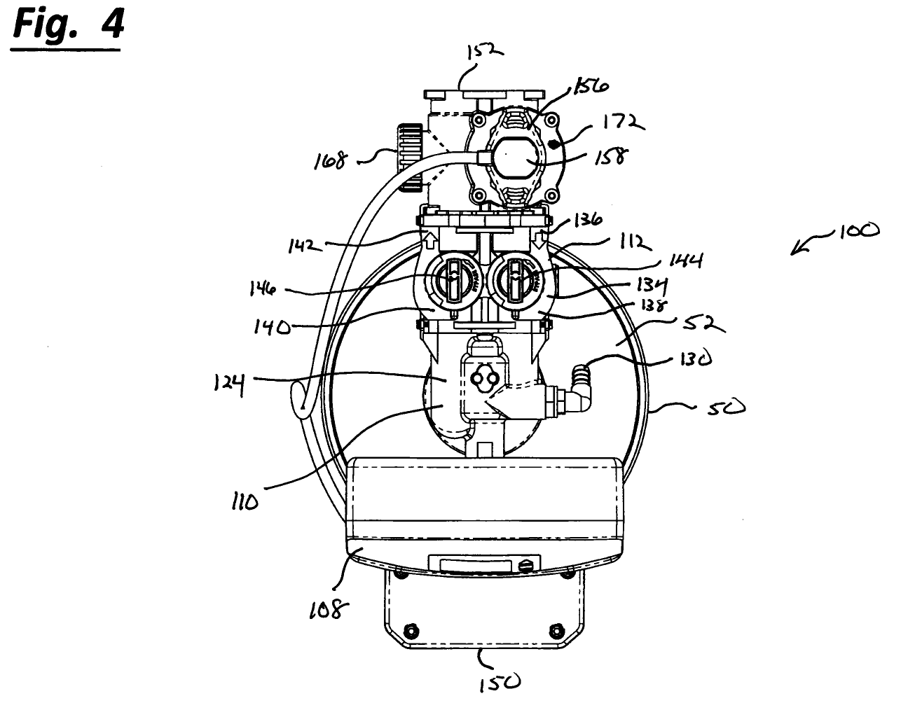

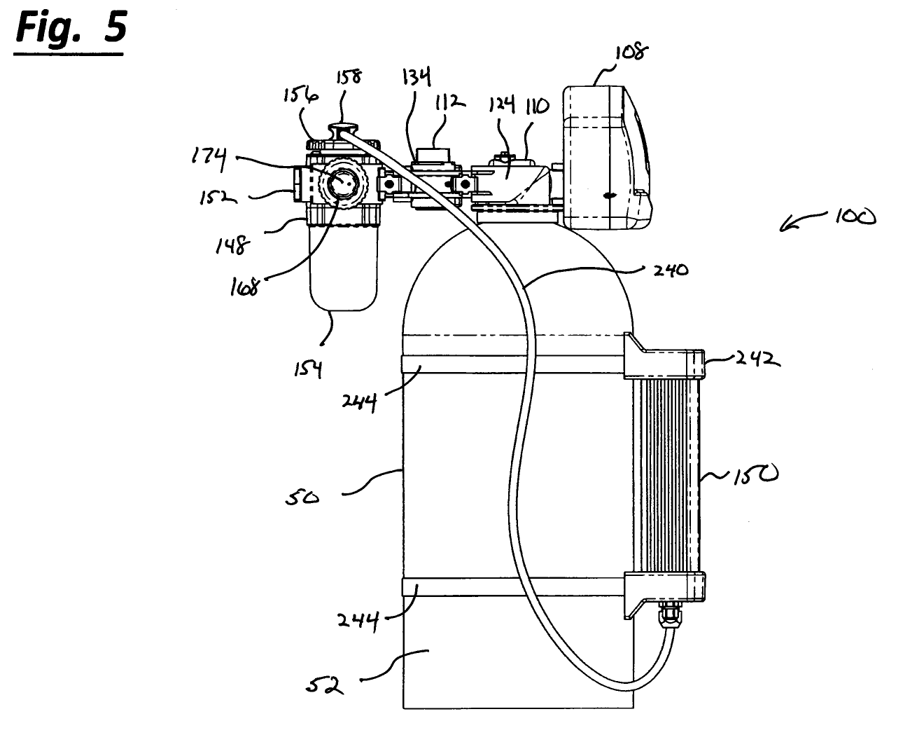

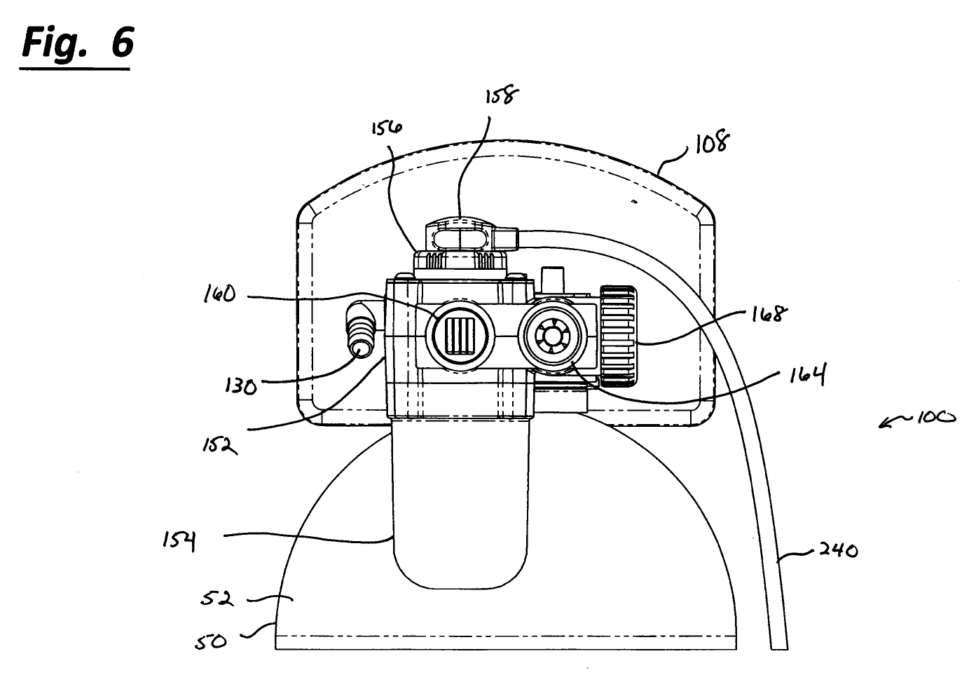

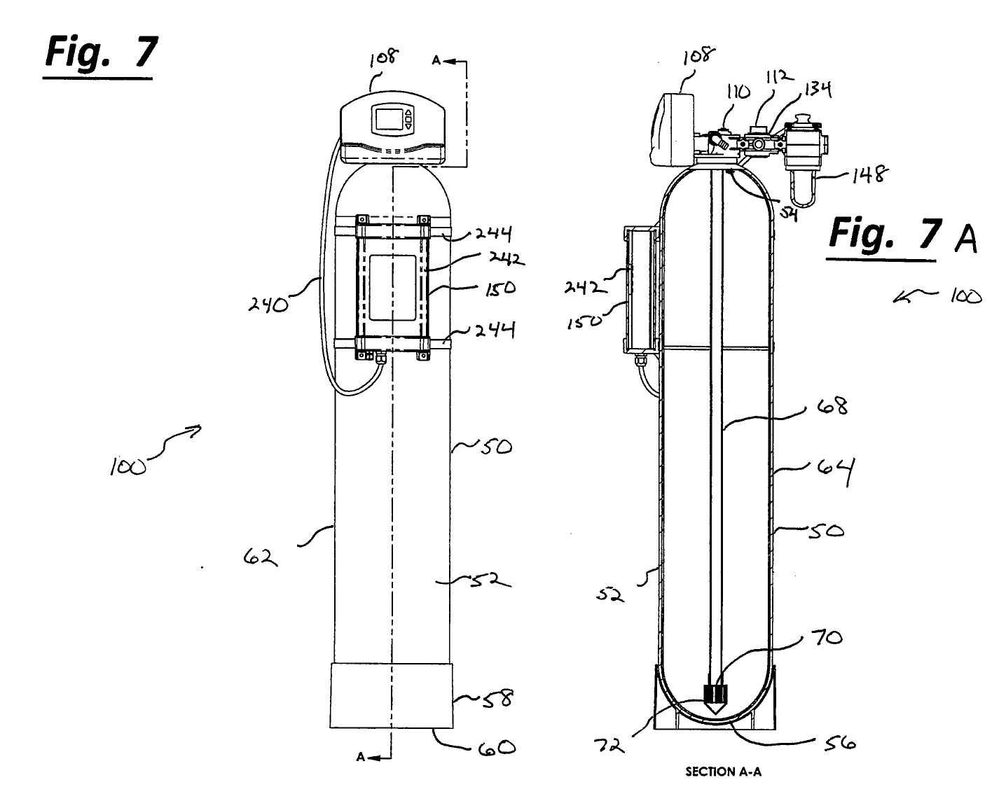

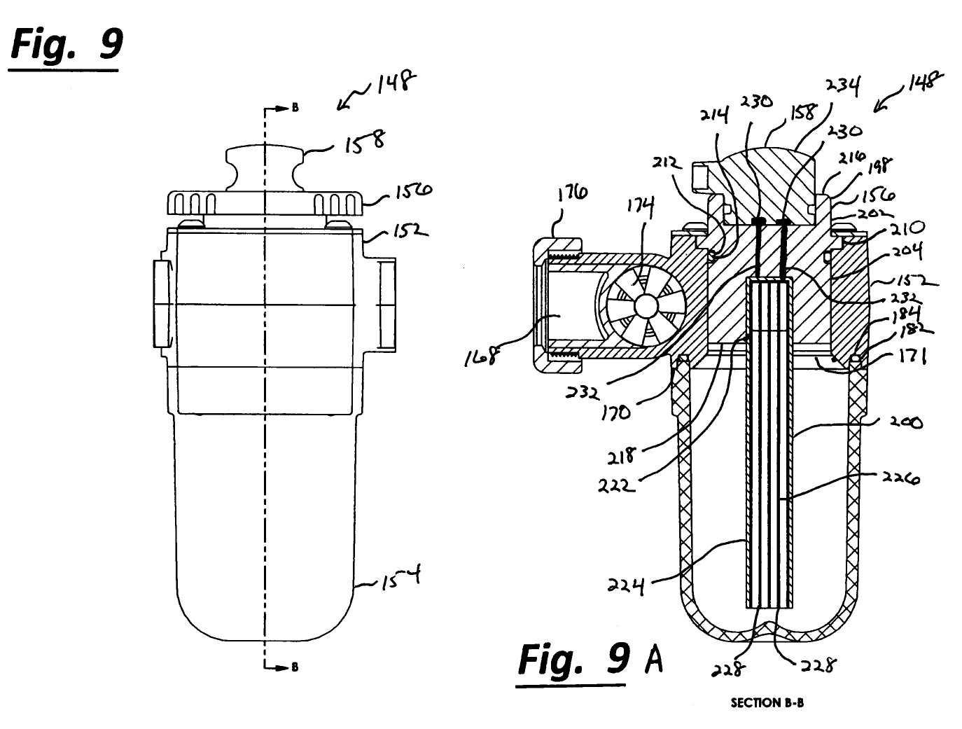

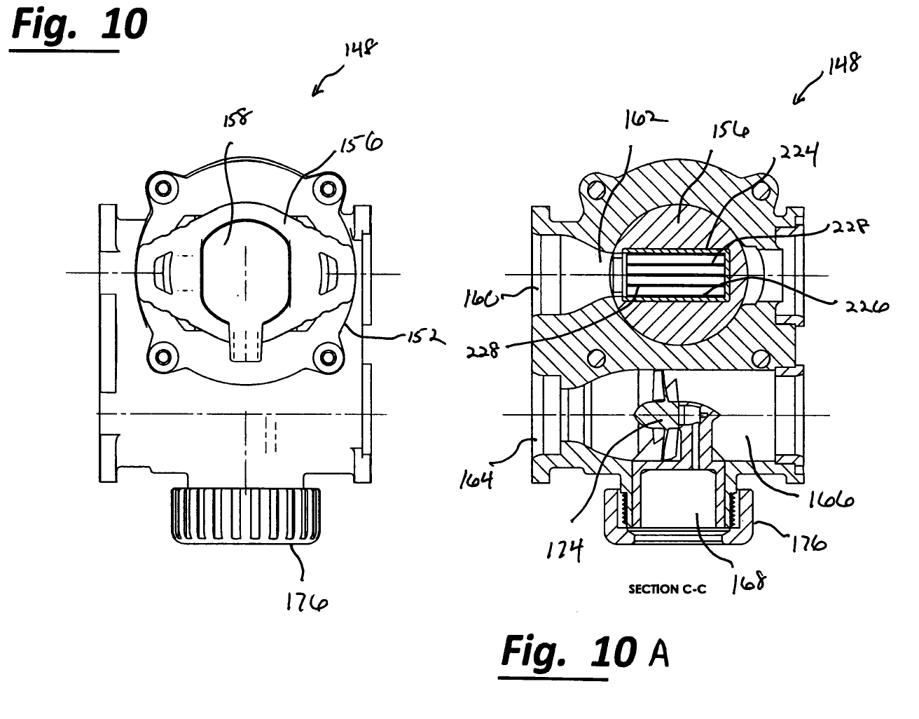

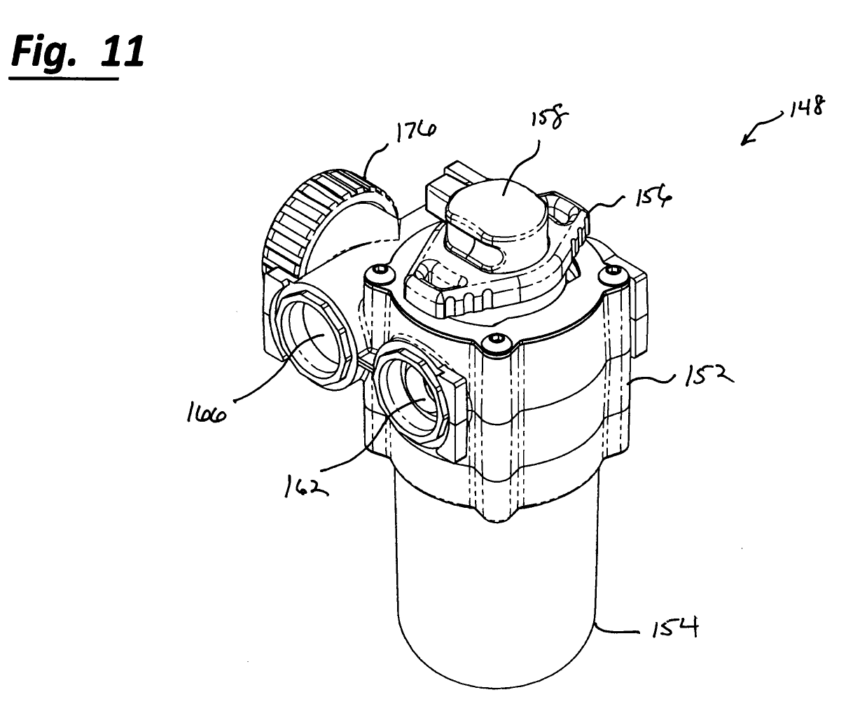

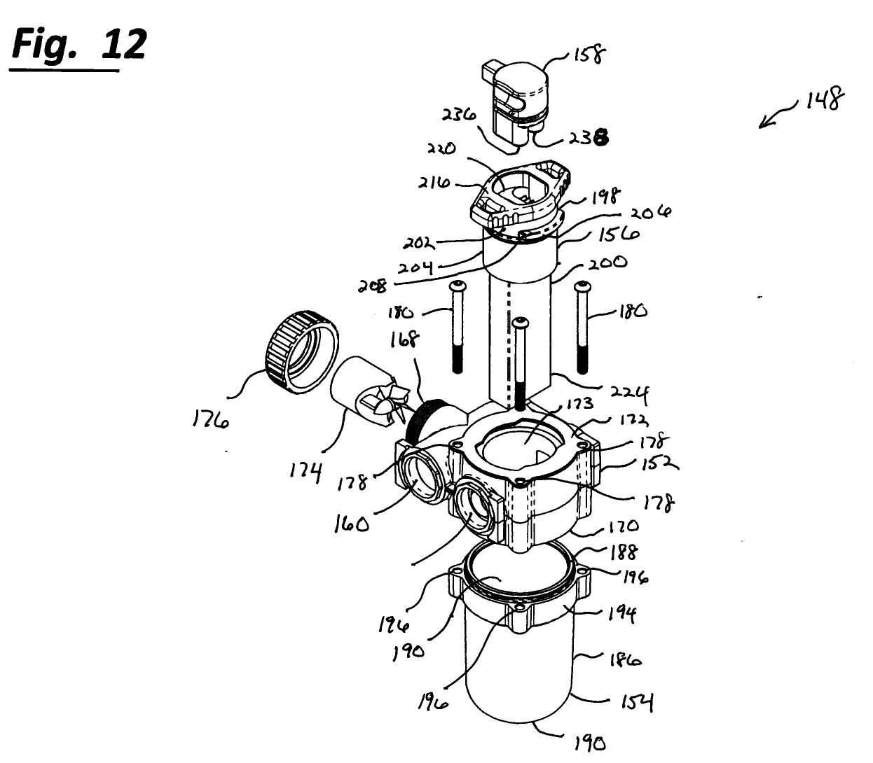

Referring to FIGS. 1-12, a first representative embodiment of an electrolytic filtration system 100 can comprise a control head assembly 102 and a filter assembly 50. Electrolytic filtration system 100 can be fabricated, sold and installed as a complete assembly or alternatively, control head assembly 102 can be retrofitted into existing fluid system in which filter assembly 50 has been previously installed.

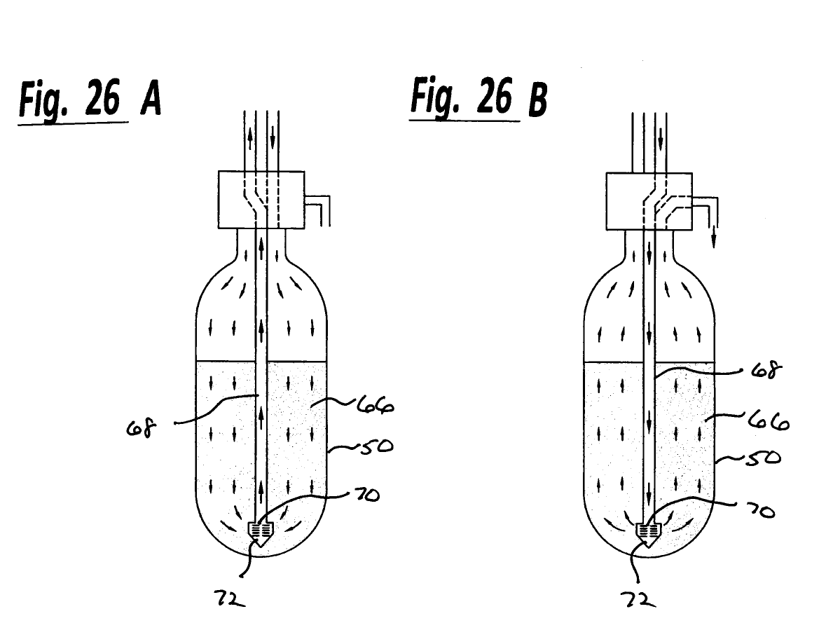

As best illustrated in FIGS. 1-7A, 26A and 26B, filter assembly 50 can comprise a generally cylindrical vessel 52 having an upper opening 54 and a closed bottom surface 56. While not illustrated, it will be understood that upper opening 54 generally includes a connecting feature, such as, for example, a threaded or flanged style connection for sealingly connecting the control head assembly 102 to the filter assembly 50. Cylindrical vessel 52 can be mounted on top of a support stand 58 having a generally flat bottom surface 60 such that electrolytic filtration system 100 remains in a generally upright, vertical disposition 62 when placed into service. Cylindrical vessel 52 generally has a continuous vessel wall 64 extending between the upper opening 54 and the closed bottom surface 56. Retained within vessel 52 is an amount of a filtration media 66 and a riser tube 68. Filtration media 66 can comprise one or more types of granular, powdered or other shaped particulates such as, for example, gravel, activated carbon, manganese greensand, ion exchange resin, ferric hydroxide and the like. Riser tube 68 generally includes an open bottom end 70 upon which a distributor basket 72 is mounted. Open bottom end 70 and filter basked 72 are generally located within and surrounded by the filtration media 66 for distributing flow throughout the filtration media while also preventing the introduction of filtration media 66 into riser tube 68 during backwash procedures. Vessel 52 can be comprised of materials compatible with and suitable for use in aqueous fluid systems. Frequently, vessel 52 is fabricated from a polyolefin liner that is reinforced on its outside by winding fiberglass and resin for structural integrity. Alternatively, many larger flow applications will use painted carbon steel or stainless steel. Conventional vessels 52 of this type can have upper opening 54 with a 2½″-8 diameter, threaded opening. In some embodiments, upper opening 54 can be flanged to allow the use of clamps for mounting control head assembly 102 independently of any threaded connection. Representative dimensions for vessel 52 can include 9″, 10″ or 12″ diameter×48″ or 54″ tall.

Referring now to FIGS. 1-12, control head assembly 102 generally comprises a flow control portion 104 and an electrolytic generator 106. Flow control portion 104 can comprise a control assembly 108, a control valve 110 and a bypass assembly 112. Control assembly 108 can include a control enclosure 114 having a display surface 116. Mounted within display surface 116 is a control instrument 118 that serves to actuate control valve 110 to selectively direct fluid flow through the filter assembly 50 based on a current mode of operation. Control instrument 118 can comprise a timer cam system or a microprocessor or circuit board based system and generally includes a display 120 and one or more input device 122 that allow an operator to select, control and verify operation of the electrolytic filtration system 100.

As shown in FIGS. 1-7B, control valve 110 generally comprises a flow body 124 having a control valve inlet 126, a control valve outlet 128 and a drain port 130. Control valve 110 can comprise a conventional flow control valve used in residential and commercial filtration application such as, for example, a Fleck® 2510 control valve available from Pentair Water as well as Autotrol flow control valves available from GE Water & Process Technologies Group and control valves manufactured by the Clack Corporation. Typical commercially available control come with a standardized port configuration of 1-⅛″ I.D.×2″ on centers. This port configuration allows for easy connection to standard bypass assemblies 112, which are commonly used to connect to the residential piping. Control valve 100 can be made from brass, bronze, stainless metals, or plastic materials such as glass-filled polyphenylene oxide (Noryl®). Though not illustrated, it will be understood that the control valve 110 generally comprises a motorized valve assembly that operates under the direction of the control instrument 118 and selectively allows and routes fluid flow through control valve inlet 126, control valve outlet 128 and drain port 130 based on the mode of operation.

Referring to FIGS. 1-7B, bypass assembly 112 generally comprises a bypass body 134 having a bypass inlet port 136, a supply port 138, a return port 140 and a bypass outlet port 142. Though not illustrated it will be understood that an inlet conduit is defined between the bypass inlet port 136 and the supply port 138, an outlet conduit is defined between the return port 140 and the bypass outlet port 142 and a bypass conduit fluidly connects the inlet conduit with the outlet conduit. The bypass conduit can include a bypass inlet valve 144 and a bypass outlet valve 146 that serve to selectively allow flow fully through the inlet conduit and outlet conduit or to alternatively close the inlet conduit and outlet conduit and allow flow only into the bypass inlet port 136, through the bypass conduit and out the bypass outlet port 142. Bypass inlet valve 144 and bypass outlet valve 146 can be manually actuated valves or alternatively, can be automated valves controlled by the control instrument 118. Bypass assembly 112 generally allows fluid flow through the inlet and outlet conduits during normal operation. Manual use of the bypass conduit is useful when there are operational issues with the filter assembly 50. Bypass assembly 112 can comprise a conventional bypass vale assembly used in residential and commercial filtration applications such as, for example, Autotrol bypass valves available from GE Water & Process Technologies Group, the Clack Corporation and Fleck® bypass valves available from Pentair Water.

As shown in FIGS. 1-12, electrolytic generator 106 can comprise a sump assembly 148 and a power supply 150. Sump assembly 148 can substantially resemble and operate in a manner similar to that disclosed in U.S. Utility patent application Ser. No. 12/790,361, filed May 28, 2010, and entitled “AXIAL-SUMP ELECTROLYTIC FLOW CELL”, the subject matter of which is herein incorporated by reference in its entirety. Sump assembly 148 can comprise a sump manifold 152, a sump chamber 154, a replaceable electrolytic cartridge 156 and a power connector 158. Sump manifold 152 generally includes a sump inlet port 160, a sump inlet conduit 162, a sump outlet port 164, a sump outlet conduit 166, a sensor port 168, a lower connecting surface 170 and an upper mounting surface 172. Lower connecting surface 170 generally defines a lower opening 171 while upper mounting surface 172 defined an upper opening 173. A flow sensor 174 can be positioned within the sensor port 168 and retained with a sensor port connector 176. Flow sensor 174 can comprise a suitable flow sensor including, for example, a turbine, paddlewheel or other appropriate flow sensing device. Sensor port 168 can be in fluid communication with the sump outlet conduit 166 though it will be understood that in certain applications it may be advantageous to have the sensor port 168 in fluid communication with the sump inlet conduit 162. Sump manifold 152 can comprise a plurality of retention apertures 178 extending between lower connecting surface 170 and the upper mounting surface 172, each retention aperture 178 accommodating a retention fastener 180. Lower connecting surface 170 can include a circumferential recess 182 for accommodating a sealing member 184.

Referring to FIGS. 1-12, sump chamber 154 generally comprises a cylindrical body 186 having a top connecting surface 188 and a closed bottom surface 190. The top connecting surface 188 defines a chamber opening 190. Top connecting surface 188 can include a circumferential lip 192 and a perimeter attachment ring 194 having one or more ring apertures 196.

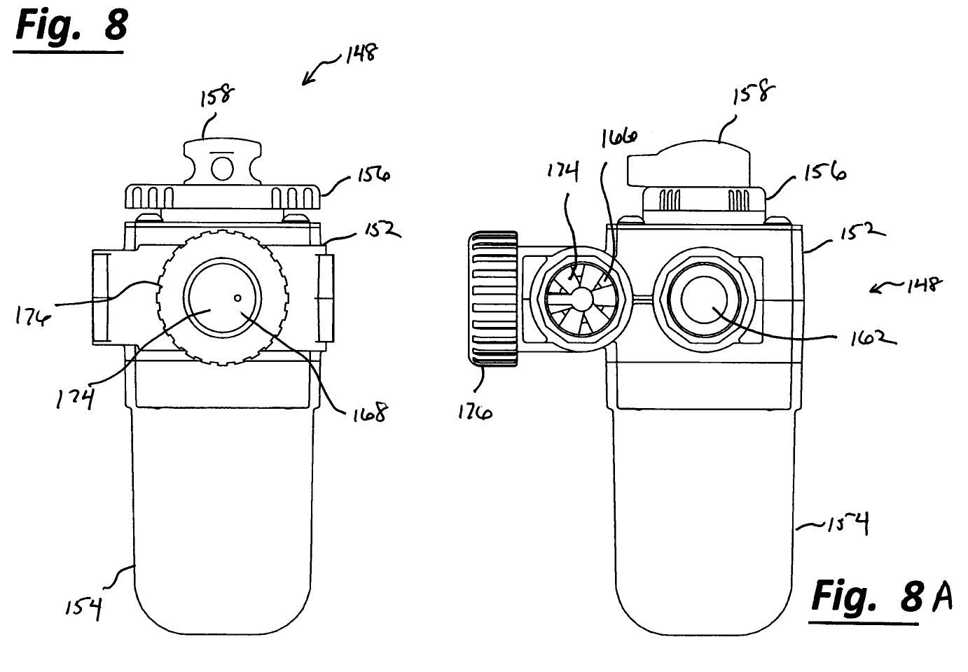

As illustrated in FIGS. 8-12, replaceable electrolytic cartridge 156 generally comprises a mounting head 198 and an electrolytic housing 200. Mounting head 198 generally defines a mounting body 202 having a mounting perimeter 204 sized to fit within the upper opening 173. Mounting perimeter 204 can include one or more mounting features 206 such as, for example, a thread or tab 208 to engage a recess 210 within the upper opening 173. Mounting feature 206 can provide for installation of the replaceable electrolytic cartridge by way of a quarter-turn bayonet tab arrangement, or alternatively via other connection methods such as, for example, threaded, twist-on or even bolt or clamp style connections. Though not illustrated, mounting head 198 can include other sensors or control circuitry including operator interface lights or buttons. Mounting perimeter 204 can further comprise a mounting channel 212 for accommodating a mounting seal 214. Mounting head 198 includes an upper mounting surface 216 and a lower mounting surface 218. Upper mounting surface 216 defines a connector recess 220 while lower mounting surface 218 defines a housing recess 222. Electrolytic housing 200 generally comprises a sleeve member 224 surrounding an electrolytic element 226. Electrolytic element 226 generally comprises spaced apart electrode plates 228 such that incoming fluid flow is directed along, between and past the plates during operation such that electrolysis can occur and the production of electrolytic gases and other electrolytic byproducts occurs. It is preferred to arrange electrode plates 228 and sleeve member 224 such that all incoming fluid flow is directed therethough. Electrolytic housing 200 is mounted within the housing recess 222. With the electrolytic housing 200 mounted within housing recess 222, electrolytic element 226 is electrically connected to electrical contacts 230 in the connector recess 220 via electrical circuit 232 within the mounting body 202.

As shown in FIGS. 1-12, power connector 158 generally has a connector body 234 configured to fit snugly within the connector recess 220. Connector body 234 includes a lower connecting surface 236 with connector contacts 238 arranged to engage the electrical contacts 230. A power cord 240 connects power connector 158 with the power supply 150 to provide a desired current level for operation of the electrolytic element 226. The current level can vary dependent upon factors such as, for example, the type and amount of dissolved solids and other contaminants within an aqueous fluid source. While power connector 158 is illustrated as being disconnectable from the mounting head 198, it will be understood that in power connector 158 can be permanently attached to the electrolytic generator 106 as desired.

Referring to FIGS. 1-7B, power supply 150 generally comprises a fluid tight enclosure 242 that can be mounted upon the cylindrical vessel 52 with one or more attachment bands 244. Alternatively, it will be understood that power supply 150 can be remotely mounted from the cylindrical vessel 52, for example, on a wall or suitable structure in proximity to the cylindrical vessel 202. Though not illustrated, it will be understood that enclosure 242 generally encloses the individual electrical components comprising power supply 150 including individual power supply elements, fusing, circuit breakers and various control elements for supplying current to the electrolytic element 226. Power supply 150 supplies the voltage and current necessary to drive the electrode plates 228 during water flow. The voltage supplied by power supply 150 is typically less than 48 volts. In some embodiments, the current can be controlled proportionally relative to one or both of the flow rate of the water and the concentration of the target contaminants. The power supply 150 can include a microprocessor to perform control algorithms and provide operator interface communication and status utilizing additional sensors such as, for example, temperature, flow, conductivity, redox and similar sensors.

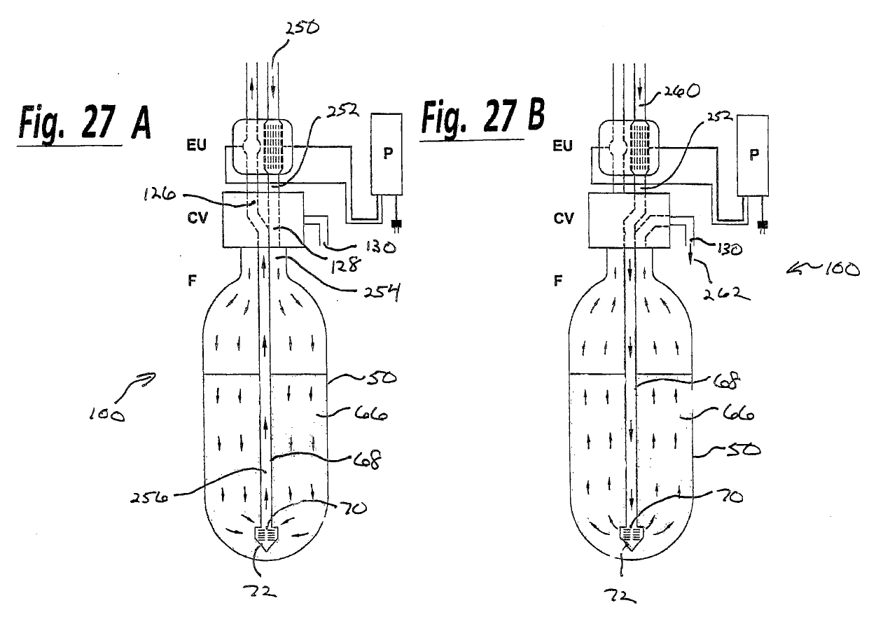

In operation, electrolytic filtration system 100 subjects an inlet aqueous fluid flow 250 to an electrolytic process within an inlet flow passage 252 defined by the sump inlet conduit 162, the inlet conduit in bypass assembly 112, and the control valve inlet 126 as shown in FIG. 27A. Inlet aqueous fluid flow 250 is directed from the sump inlet port 160, down past the electrode plates 228 and out the bottom of the sleeve member 224. The downward flow of inlet aqueous fluid flow 250 allows gravity to assist with keeping the electrode plates 228 clean so that any scale will fall into the sump chamber 154. In this manner, contaminants such as scale including calcium, magnesium carbonates, bicarbonates, etc. as well as iron, manganese or other metals (chromium, uranium, arsenic, aluminum, and antimony) or hydrogen sulphide and even VOC's such as pesticides, herbicides, and minerals within the inlet aqueous fluid flow 250 which are precipitated during exposure to high-energy electrolytic activity are subjected to electrolytically generated gasses and byproducts within the inlet flow passage 252 prior to entering the filter assembly 50. Oxidation of these dissolved solids occurs almost instantaneously upon exposure to the electrolytic gases and electrolytic byproducts such that the oxidized elements have either begun to precipitate or are in the process of precipitating as an electrolytically exposed inlet aqueous fluid flow 254 enters filter assembly 50 through the upper opening 54 via control valve 110. As the electrolytically exposed aqueous fluid flow 254 flows through the filtration media 66, any precipitated solids as well as particulate matter and other suspended solids are filtered and removed to create a filtered aqueous fluid flow 256 that enters the distributor basket 72 and leaves the filter assembly 50 through the riser tube 68. Experimentation has shown that the precipitated minerals and contaminants are captured primarily with the foremost surface margin of the filtration media 66 due to the rapid precipitation following exposure to the electrolytically generated gases and electrolysis byproducts. In some embodiments, the rapid precipitation allows for the use of shorter vessels 52 than conventionally used so as to allow the electrolytic filtration system 100 to be more compact. Additional precipitation can occur throughout the filter media 66. The filtered aqueous fluid flow 256 enters the control valve 110 whereby the filtered aqueous fluid flow 256 exits the electrolytic filtration assembly 100 through an outlet flow passage 258 defined by the control valve outlet 128, the optional outlet conduit in bypass assembly 112 and the sump outlet conduit 166 for distribution to points of use. As the filtered aqueous fluid flow 256 is directed from the electrolytic filtration assembly 100, flow sensor 174 detects flow through the sump outlet conduit 166 and provides a signal to the power supply 150 directing the power supply to power the electrolytic element 226 via the power connector 158. In the event that flow sensor 174 fails to detect flow through the sump outlet conduit 166, flow sensor 174 sends a signal to the power supply 150 to prevent the power supply 150 from powering the electrolytic element 226 during periods of nonuse.

Depending upon the amount of dissolved, particulate and suspended solids contained within inlet aqueous fluid flow 250 or in the event that the filtration media 66 at least partially comprises a media requiring regeneration such as, for example, ion exchange resin or manganese greensand, it may be desirable to backwash the filter assembly 50 to removed filtered contaminants from the filtration media. As shown in FIG. 27B, a backwash process is accomplished through manipulation of control valve 110 such that a backwash fluid flow 260 is directed through the inlet flow passage 252, into the riser tube 68 and out the distributor basket 72 at the bottom of the filtration media 66. Backwash fluid flow 260 flows upward through the filtration media 66 causing the filtration media 66 to separate and expand such that contaminants trapped within the filtration media 66 can be flushed out the upper opening 54 into control valve 110 whereby a waste fluid flow 262 can be directed to sewer or for further treatment through drain port 130. While it is generally desired that electrolytic element 226 is not powered when there is no flow through sump outlet conduit 166, it can be desirable for the control instrument 118 to communicate with the power supply 150 such that the electrolytic element 226 is powered during a final backwash rinse.

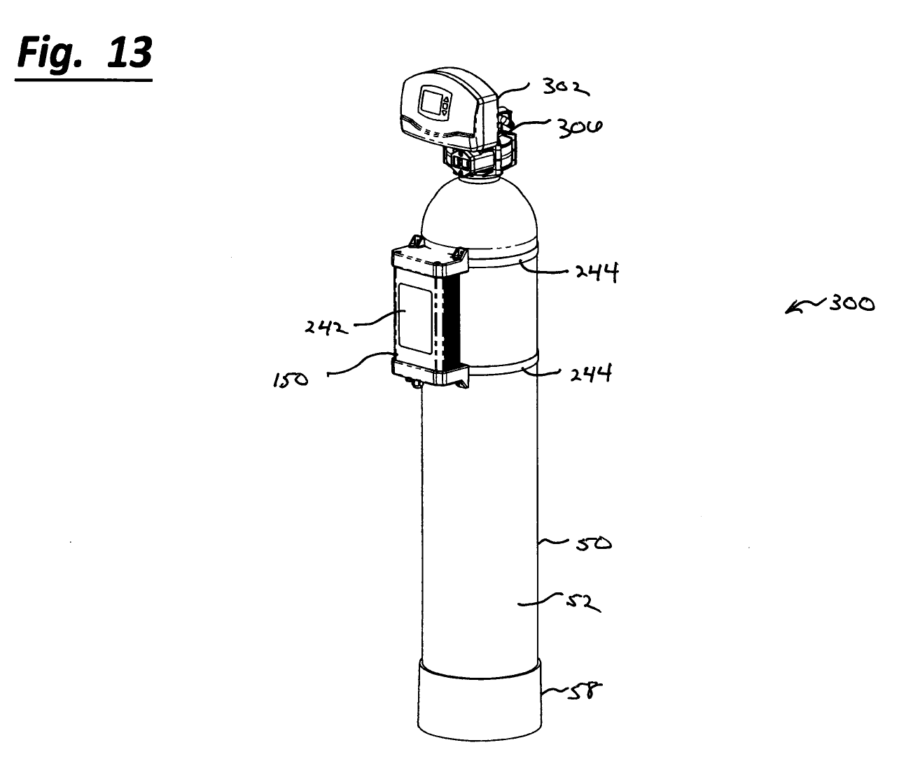

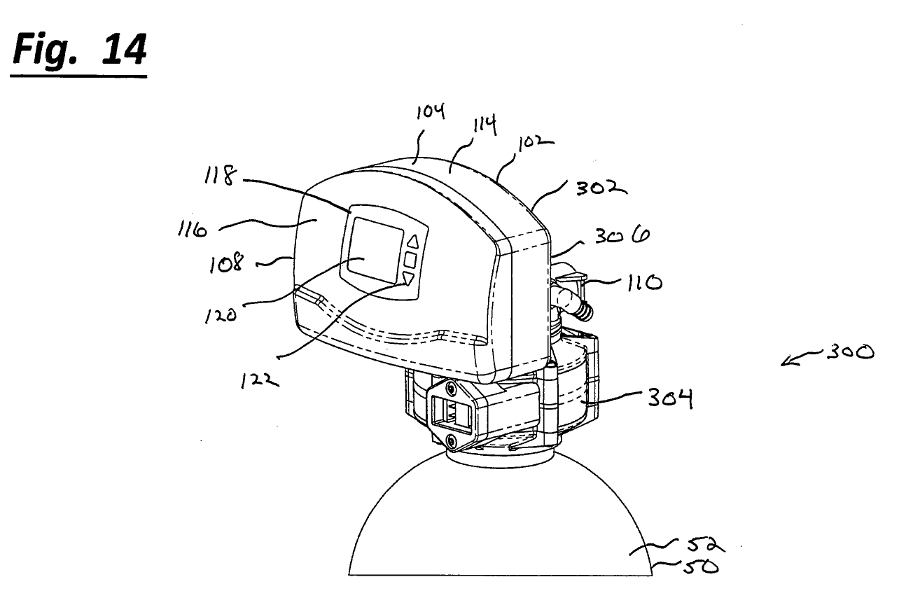

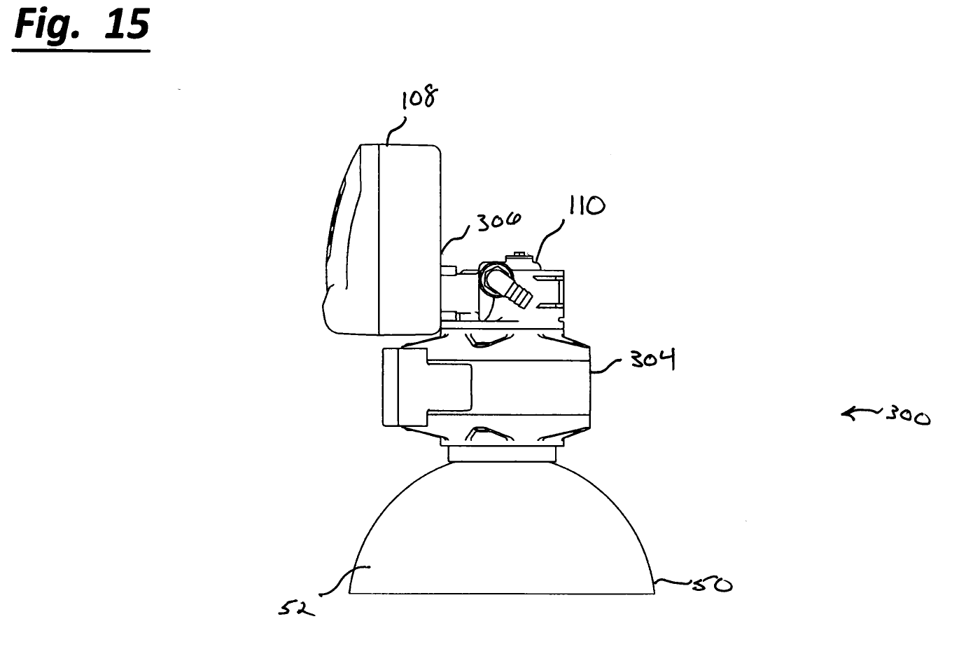

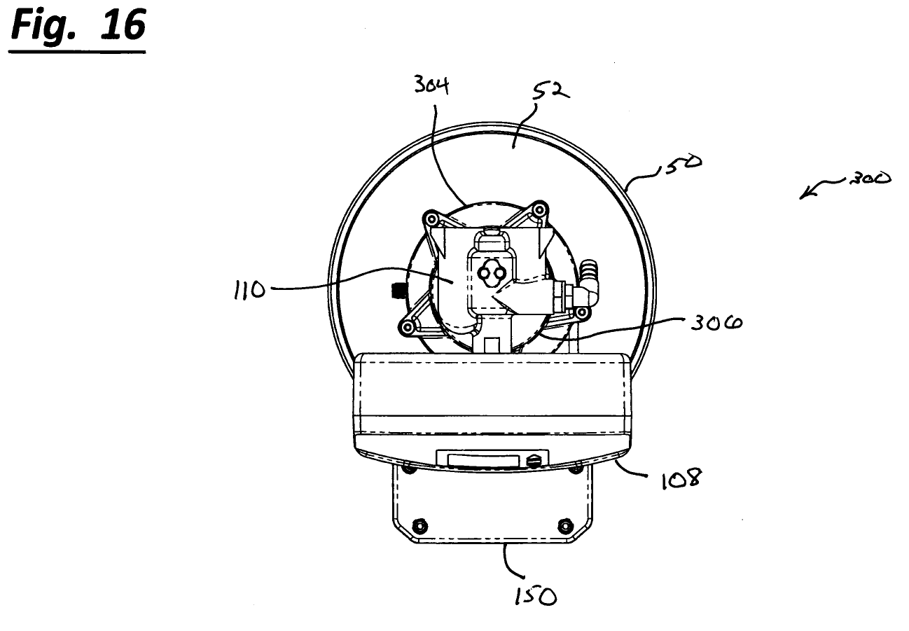

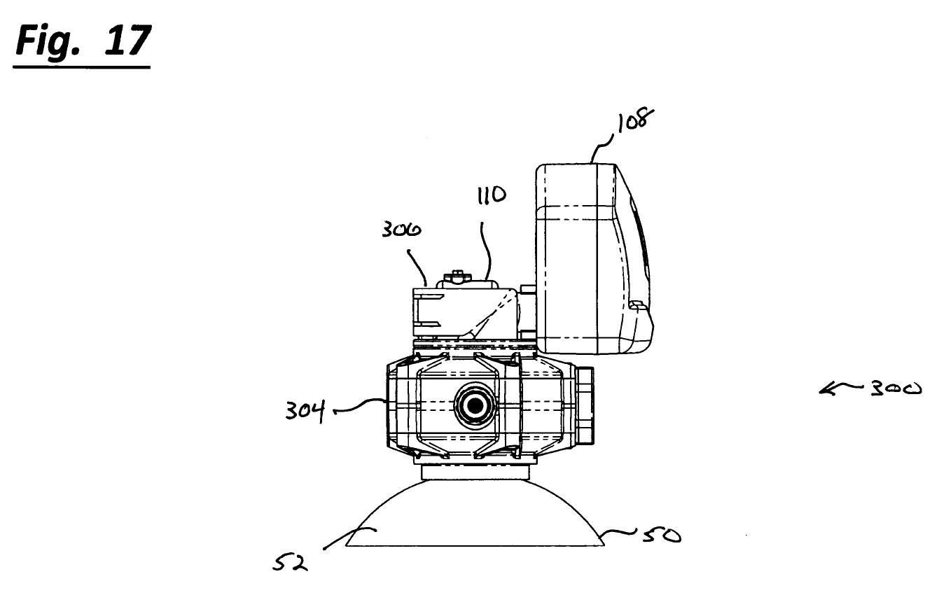

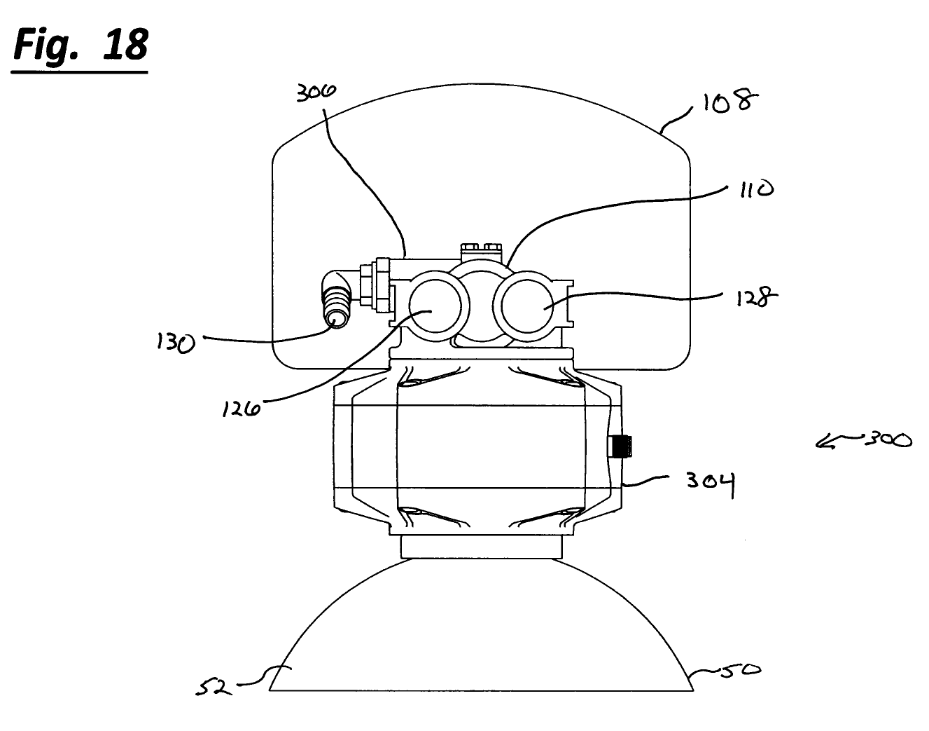

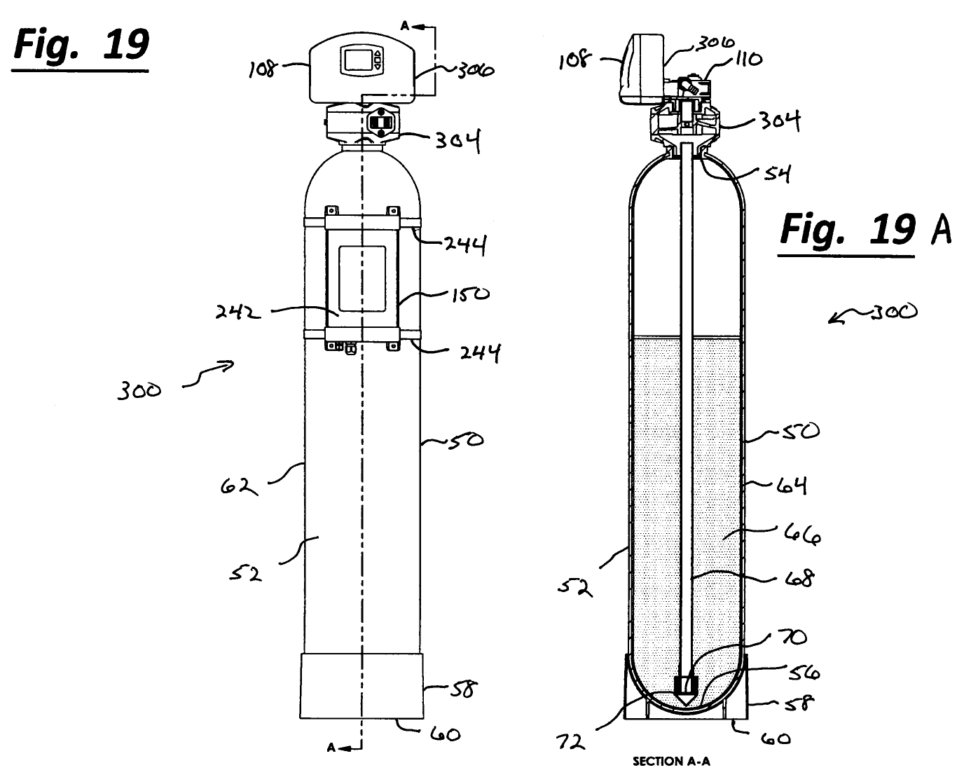

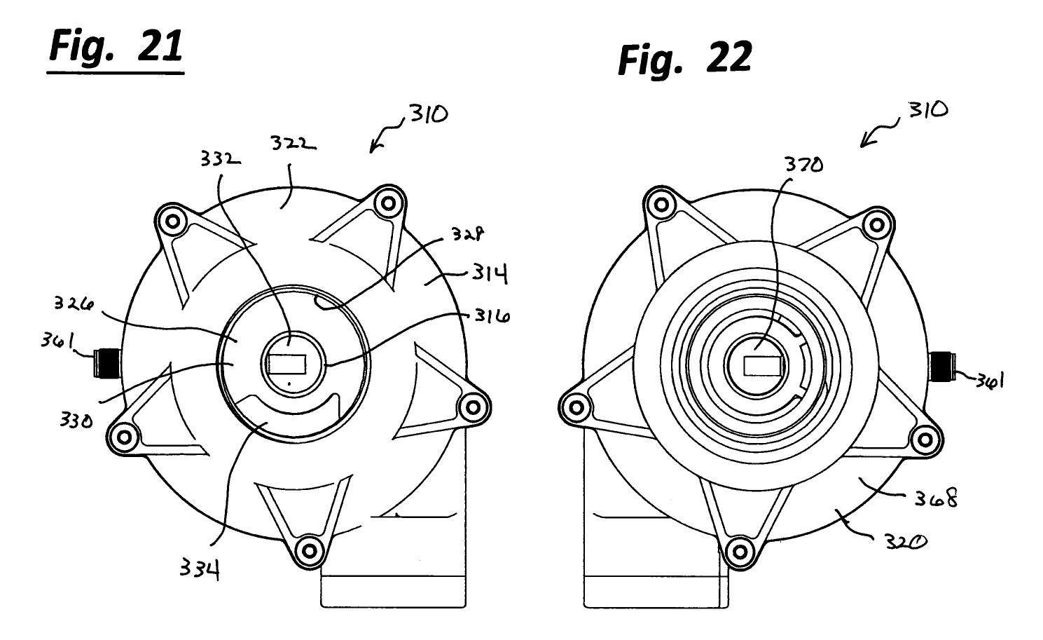

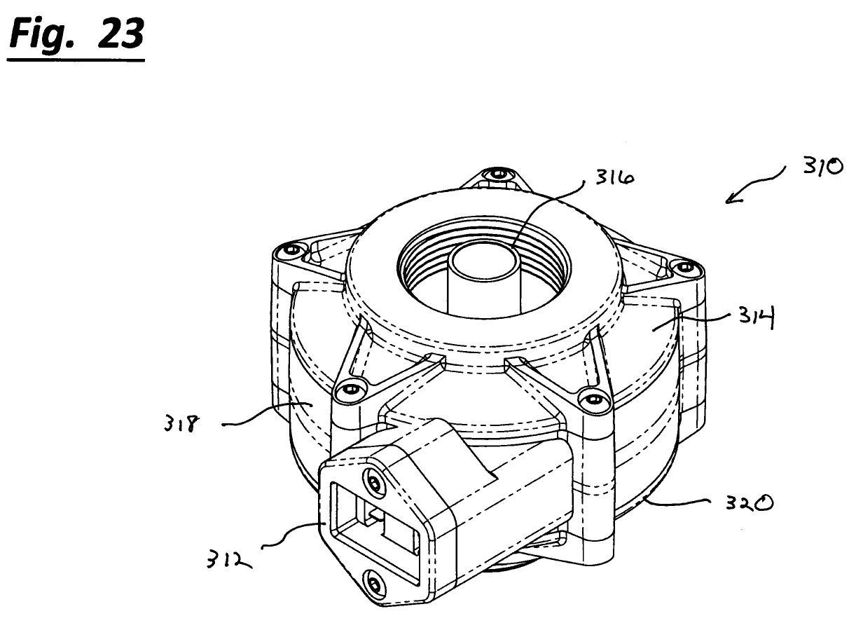

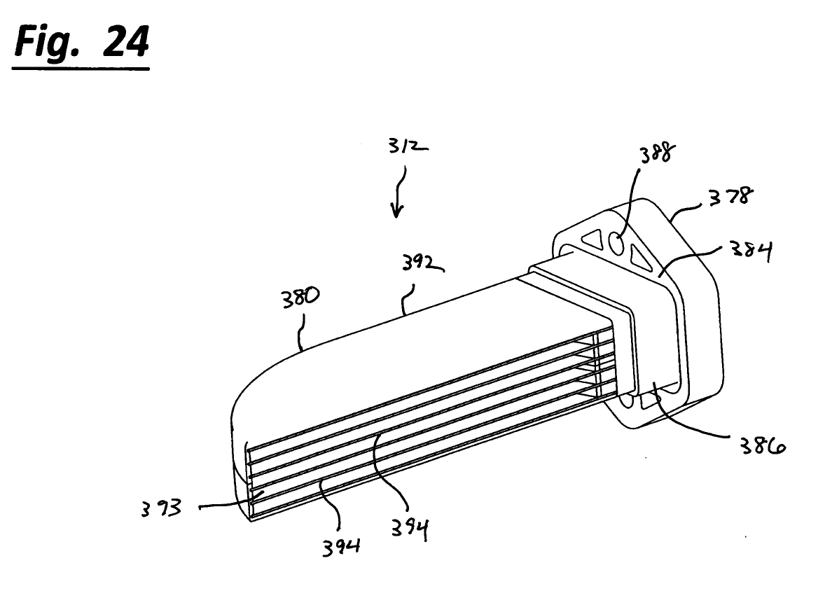

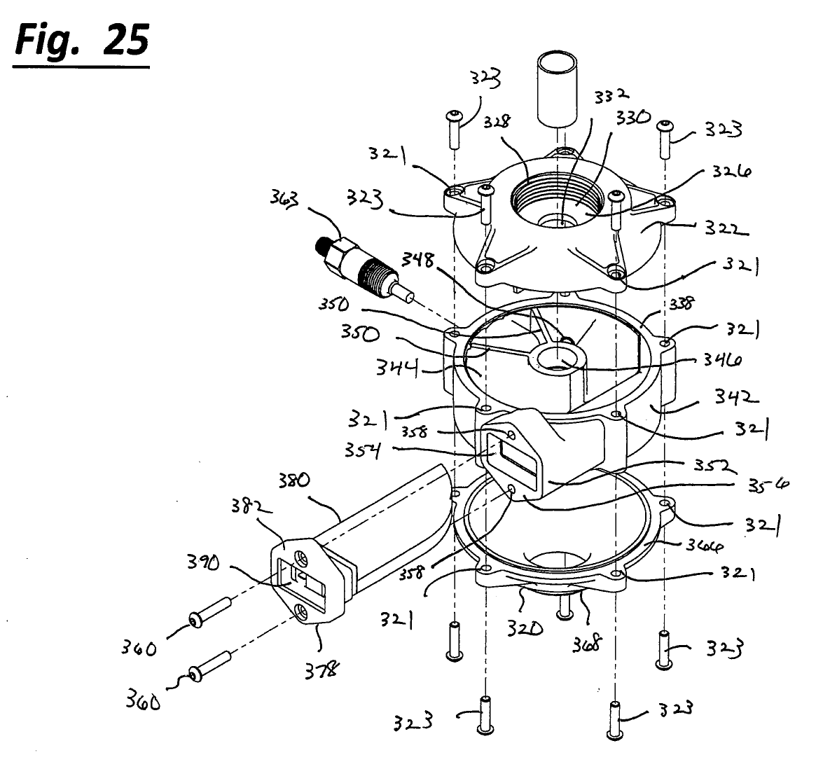

Referring now to FIGS. 13-25, an alternative embodiment of an electrolytic filtration system 300 can comprise a control head assembly 302 and filter assembly 50. As similarly described with respect to electrolytic filtration system 100, electrolytic filtration system 300 can be fabricated, sold and installed as a complete assembly or alternatively, control head assembly 302 can be retrofitted into existing fluid systems in which filter assembly 50 has been previously installed. Electrolytic filtration system 300 differs from electrolytic filtration system 100 in that an electrolytic generator 304 is positioned below or after the control valve 110. Positioning the electrolytic generator 304 after the control valve 110 can provide advantages to electrolytic filtration system 300 with respect to better control of scaling/fouling caused by rapid precipitation of dissolved minerals, creating better interchangeability of the electrolytic generator 304 with commercially available control valves 110 and by allowing for safe operation of the electrolytic generator 304 during the entire backwash procedure.

With respect to the scale control, location of the electrolytic generator 106 prior to the control valve 110 in electrolytic filtration system 100 can result in scaling and fouling of the inlet flow passage 252 as well as the valve mechanisms and flow ports of the control valve 110 and bypass assembly 112. When the electrolytic generator 304 is positioned after the control valve 110 as shown with electrolytic filtration system 300, all of the precipitated minerals and contaminants are immediately directed into the filter assembly 50 for removal.

With respect to interchangeability, inlet and outlet port configurations on control valve 110 can vary depending upon the manufacturer. As such, sump manifold 152 must generally be configured for specific models of control valve 110 and bypass assembly 112 when electrolytic generator 106 is positioned before the control valve 110 as found in electrolytic filtration system 100. Variations between control valves 110 of different manufacturers can include port size as well as center to center spacing of ports. Electrolytic filtration system 300 addresses this issue through the use of electrolytic generator 304 utilizing an adapter to connect to each type of control valve 110 on a valve end but remaining commonly connectable as a component of the electrolytic generator 304. The electrolytic generator 304 is directly connectable to the vessel 52. This common mounting design provides for a more compact and robust arrangement as well as there no longer is a requirement for space beyond the diameter of the vessel 52 as is required with electrolytic filtration system 100.

With respect to flow sensing, placement of the electrolytic generator 304 below the control valve 110 avoids the situation during a backwash cycle of the filter assembly 50 when there is no fluid flow past a flow sensor. When the electrolytic generator 304 is positioned between the control valve 110 and the filter assembly 50, all of the fluid flow is directed past the flow sensor but in a reverse direction from normal operation. With electrolytic filtration system 300, the flow sensor within the electrolytic generator should detect flow regardless of direction.

As shown in FIGS. 13-19B, control head assembly 302 generally comprises electrolytic generator 304 and a flow control portion 306. Flow control portion 306 generally includes control assembly 108 and control valve 110. Though not illustrated, it will be understood that bypass assembly 112 can optionally be included as part of the flow control portion 306 or alternatively, bypass assembly 112 can be installed as part of a plumbing system to effectively isolate the electrolytic filtration system 300 in the event of a system failure or if the electrolytic filtration system 300 is in a backwash mode.

Referring to FIGS. 13-25, electrolytic generator 304 generally comprises an electrolytic housing 310, a replaceable electrolytic cartridge in the form of an electrolytic blade pack 312 and power supply 150. Electrolytic housing 310 can include an adaptor plate 314, an adaptor tube 316, an electrolytic manifold 318 and a vessel connection plate 320. Arranged about the perimeter portions of adapter plate 314, electrolytic manifold 318 and vessel connection plate 320 are a plurality of housing apertures 321 that are aligned such that connectors 323 can be utilized to operably join and retain the components of the electrolytic housing 310. Electrolytic housing 310 can be injection molded using the same polymer that most control valves 110 are molded from, polyphenylene oxide (PPO).

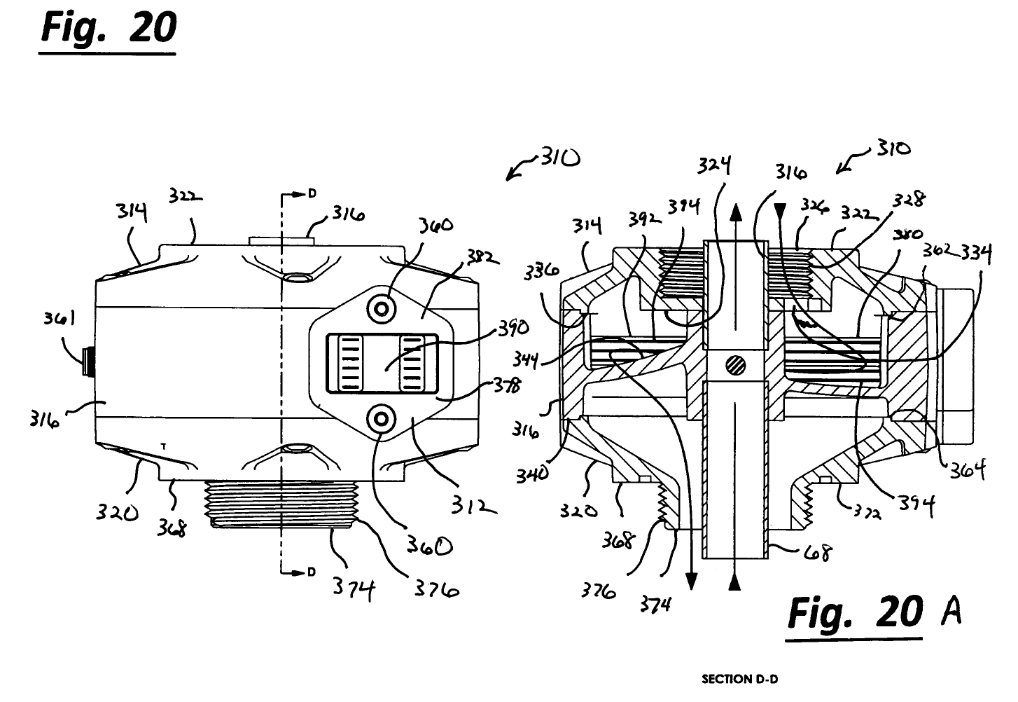

As shown in FIGS. 20-23 and 25, adapter plate 314 generally includes an upper surface 322 and a lower surface 324. Upper surface 324 includes a connection recess 326 including an inner thread 328 and a recess surface 330. Recess surface 330 includes a central aperture 332 and an off-center surface aperture 334. Central aperture 332 and surface aperture 334 both fully extend between the upper surface 322 and the lower surface 324. Lower surface 324 includes a circumferential projection 336. Depending upon the manufacturer and style of control valve 110, the dimensioning of connection recess 326 and the relative spacing of the central aperture 332 and surface aperture 334 can be varied without requiring the use of a dimensionally different electrolytic manifold 318. Electrolytic manifold 318 generally comprises a manifold upper surface 338, a manifold lower surface 340 and a manifold perimeter wall 342. Manifold upper surface 338 comprises an angled surface 344, a central manifold aperture 346, an offset manifold aperture 348 and a pair of flow ribs 350. Manifold perimeter wall 342 includes a blade pack mounting port 352 having a pack opening 354 that is open and exposed to the manifold upper surface 338. Blade pack mounting port 352 includes a pack mounting surface 356 including one or more pack mounting apertures 358 for accommodating pack mounting fasteners 360. Manifold perimeter wall 342 further comprises a sensor port 361 for mounting a flow sensor 363 that extends into central manifold aperture 346. Flow sensor 363 can comprise a suitable sensor capable of measure flow in both forward and reverse direction such as, for example, a thermal dispersion type that determines the relative cooling effects of flow based upon whether it is stagnant or flowing. The cooling effect is different on the tip of the sensor 363 in the center of a flow stream as compared to the base of the sensor 363 next to a conduit wall where the flow is reduced. The difference in these two cooling rates can be converted into no-flow and proportional flow rates. Central manifold aperture 346 and offset manifold aperture 348 extend from manifold upper surface 338 to manifold lower surface 340. Manifold upper surface 338 includes an upper circumferential recess 362 and manifold lower surface 340 includes a lower circumferential recess 364.

Referring again to FIGS. 20-23 and 25, vessel connection plate 320 includes an upper connection surface 366 and a lower connection surface 368. A connection aperture 370 extends between the upper connection surface 366 and the lower connection surface 368. The lower connection surface 368 includes a connection flange 372 and a projecting member 374 having an exterior thread 376. Projection member 374 is sized such that the exterior thread 376 can engage a corresponding connection feature on the upper opening 54 of the vessel 52 for operably coupling the electrolytic generator 304 to the vessel 52.

As shown in FIGS. 20-25, blade pack 312 generally comprises a mounting head 378 and an electrolytic element 380. Mounting head 378 includes an exterior surface 382, a flanged surface 384 and an interface block 386. Exterior surface 382 includes one or more pack apertures 388 and an electrical connector recess 390. Pack apertures 388 extend through to flanged surface 384 and are arranged to correspond with pack mounting apertures 358. Interface block 386 is sized and shaped to snugly and sealingly fit with the pack opening 354 wherein pack mounting fasteners are inserted into the pack apertures 388 and pack mounting apertures 358 to couple the blade pack 312 to the electrolytic manifold 318. Alternative, blade pack 312 and pack opening 354 can be designed to be cylindrical such that connection can be accomplished via a quarter-turn bayonet system, a threaded cap, or clamp style fastener as desired. Electrolytic element 380 comprises a tapered sleeve 392 having a sleeve opening 393 and a plurality of electrode blades 394. Generally the electrode blades 394 are electrically connected to electric contacts that are exposed in the electrical connector recess 390 such that power connector 158 can be inserted into the electrical connector recess 390 to electrically connect the electrode blades 394 with the power supply 150. The tapered sleeve 392 can be made from a scale resistant material such as a polyolefin and the mounting head 378 can be made from a structural plastic such as, for example, polyphenylene oxide (Noryl®).

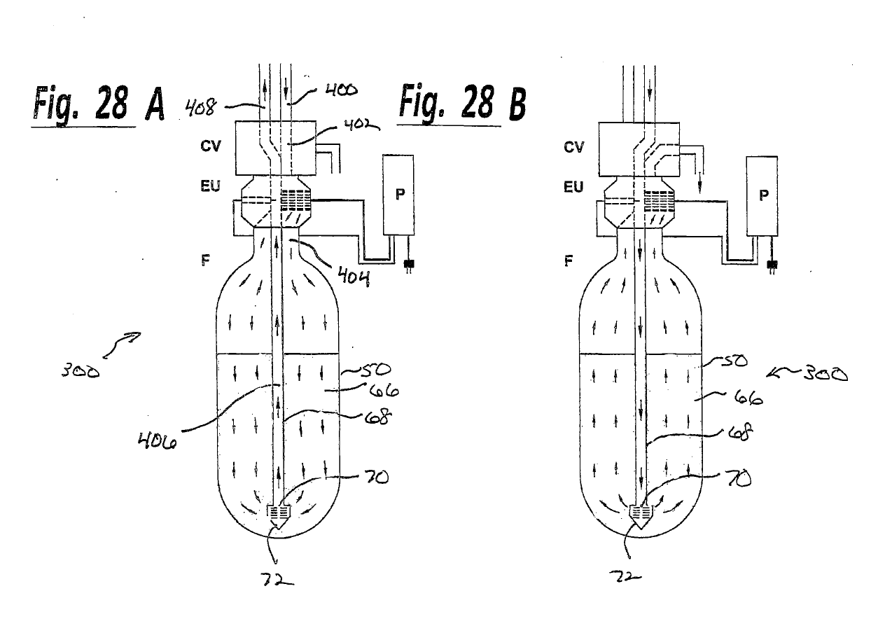

In operation, electrolytic filtration system 300 directs an inlet aqueous fluid flow 400 within an inlet flow passage 402 defined by the control valve inlet 126 as shown in FIG. 28A. Inlet aqueous fluid flow 400 is directed from the control valve inlet 126 into the connection recess 326 where adaptor tube 316 serves as a physical barrier between the central aperture 332 and the surface aperture 334. Inlet aqueous fluid flow 400 flows through the surface aperture 334 and contacts the angled surface 344 of the manifold upper surface 338. Angled surface 338 causes the direction of the inlet aqueous fluid flow 400 to divert to helical orientation, whereby it is directed into sleeve opening 393 and over and across electrode blades 394. Angled surface 338 is preferably ramped to be at least as high as the vertical height of the blade pack 312. By ramping the angled surface 338, a well or sump is formed which holds enough water to always cover the electrode blades 394. As a fluid when falling vertically will not always fill the conduit, absence of ramping on angled surface 338 can result in electrode blades being only partially covered with fluid or potentially even dry. Contaminants such as iron, manganese or other metals (chromium, uranium, arsenic, aluminum, and antimony) or hydrogen sulphide and even VOC's such as pesticides, herbicides, and minerals within the inlet aqueous fluid flow 400 which are precipitated during exposure to high-energy electrolytic activity are subjected to electrolytically generated gasses and byproducts within the inlet flow passage 400 prior to entering the filter assembly 50. Oxidation of these dissolved solids occurs almost instantaneously upon exposure to the electrolytic gases and electrolytic byproducts such that the oxidized elements have either begun to precipitate or are in the process of precipitating as an electrolytically exposed inlet aqueous fluid flow 404 exits the electrolytic manifold 318 via the offset manifold aperture 348. Flow ribs 350 physically prevent inlet aqueous fluid flow 400 from bypassing the electrolytic element 380 based on the relative positioning of the surface aperture 334 and the offset manifold aperture 348. The electrolytically exposed inlet aqueous fluid flow 404 is physically separated from a returning filtered aqueous fluid flow 406 by riser tube 68 that extends upward from the filter assembly 50 and connects to central manifold aperture 346, adaptor tube 316 and control valve outlet 128 to define an outlet flow passage 408. The filtered aqueous fluid flow 406 exist the outlet flow passage 408 for distribution to points of use. As the filtered aqueous fluid flow 406 is directed from the electrolytic filtration assembly 300, flow sensor 363 monitors for flow within the outlet flow passage 408 and provides a signal to the power supply 150 directing the power supply to power the electrolytic element 380 via the power connector 158. In the event that flow sensor 363 fails to detect flow through the outlet flow passage 408, flow sensor 363 sends a signal to the power supply 150 to prevent the power supply 150 from powering the electrolytic element 380 during periods of nonuse.

In contrast to electrolytic filtration system 100, the flow sensor 363 in electrolytic filtration system 300 continually experiences flow during a backwash procedure, albeit in a reverse direction than during normal filtering operation as shown in FIG. 28B. This allows for the electrolytic element 380 to be powered throughout a backwash cycle if desired by an operator.

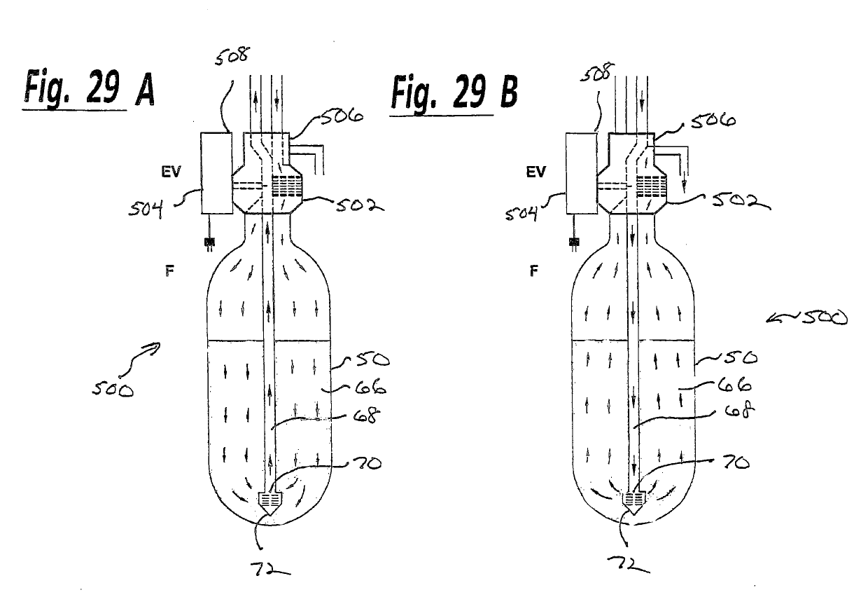

Referring now to FIGS. 29A and 29B, an embodiment of an electrolytic filtration system 500 can substantially resemble the arrangement and operation of electrolytic filtration system 300 with the exception that a control head assembly 502 is fabricated such that an electrolytic generator 504 and a flow control portion 506 comprise a single unitary, electrolytic filtration head 508 attached to filter assembly 50.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents.

1. A electrolytic filtration system, comprising:
a filter vessel for containing a filter media, the filter vessel including a vessel opening; and
a control head assembly defining an inlet flow passage and an outlet flow passage, wherein an electrolytic generator is attached to the control head assembly such that an inlet fluid flow introduced through the inlet fluid flow passage is exposed to the electrolytic generator.

2. The electrolytic filtration system of claim 1, wherein the electrolytic generator comprises a replaceable electrolytic cartridge, said replaceable electrolytic cartridge being removably attached to the control head assembly.

3. The electrolytic filtration system of claim 2, wherein the replaceable electrolytic cartridge mounts directly within an electrolytic manifold such that an electrolytic element is positioned directly within with the inlet fluid flow.

4. The electrolytic filtration system of claim 2, wherein the replaceable electrolytic cartridge is mounted within a sump assembly comprising a sump manifold and a sump chamber, the sump manifold being fluidly connected with the inlet flow passage.

5. The electrolytic filtration system of claim 2, wherein the replaceable electrolytic cartridge is rotatably attached to the control head assembly.

6. The electrolytic filtration system of claim 1, wherein the filter media is selected from the group consisting essentially of: anthracite, sand, garnet, ion exchange resin and a coated granular media.

7. The electrolytic filtration system of claim 1, wherein the control head assembly includes a flow valve within the outlet flow passage, said flow valve controlling operation of the electrolytic generator only when fluid flow is detected within the outlet flow passage.

8. A control head assembly for directing flow through a filter assembly, the control head assembly comprising:
a control valve defining an inlet flow passage and an outlet flow passage; and
an electrolytic generator attached to the control valve, the electrolytic generator being fluidly exposed to the inlet flow passage.

9. The control head assembly of claim 8, wherein the electrolytic generator comprises a replaceable electrolytic cartridge, said replaceable electrolytic cartridge being removably attached to the electrolytic generator.

10. The control head assembly of claim 9, wherein the replaceable electrolytic cartridge mounts directly within an electrolytic manifold such that an electrolytic element is positioned directly within an inlet fluid flow.

11. The control head assembly of claim 9, wherein the replaceable electrolytic cartridge is mounted within a sump assembly comprising a sump manifold and a sump chamber, the sump manifold being fluidly connected with the inlet flow passage.

12. The control head assembly of claim 9, wherein the replaceable electrolytic cartridge is rotatably attached to the electrolytic generator.

13. The control head assembly of claim 8, further comprising a flow sensor mounted in the outlet flow passage, said flow sensor preventing operation of the electrolytic generator when fluid flow is absent from the outlet flow passage.

14. A method for filtering an aqueous fluid, comprising:
providing a control head assembly including an electrolytic element fluidly exposed to an inlet flow passage;
attaching the control head assembly to a filter assembly, the filter vessel including a filter media;
controlling aqueous fluid flow into the filter vessel with the control head assembly;
supplying power to the electrolytic element to generate electrolytic byproducts within the aqueous fluid flow;
exposing contaminants in the aqueous fluid flow to the electrolytic byproducts; and
removing precipitated contaminants with the filter media.

15. The method of claim 14, further comprising:
backwashing the filter assembly to remove the precipitated contaminants from the filter media.

16. The method of claim 14, further comprising:
coupling a replaceable electrolytic cartridge including the electrolytic element to an electrolytic manifold attached to the control head assembly such that the electrolytic element is mounted directly inline with the aqueous fluid flow.

17. The method of claim 14, further comprising:
mounting a sump assembly including the electrolytic element to the control head assembly, wherein the sump assembly defines a portion of the inlet flow passage.

18. The method of claim 14, further comprising:
monitoring aqueous fluid flow with a flow sensor; and
preventing operation of the electrolytic element when the flow sensor fails to detect any aqueous fluid flow.
